(19) United States
(12) Patent Application Publication
(10) Pub. No.: US 2010/0128800 A1
(43) Pub. Date: May 27, 2010

(54) Method and Apparatus for Closed Caption Transcoding

(75) Inventors: Yong He, San Diego, CA (US); Shanhua Xue, San Diego, CA (US); Chang-An L. Hsiao, Poway, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/276,896

(22) Filed: Nov. 24, 2008

(51) Int. Cl. H04N 11/02

(52) U.S. Cl. 375/240.25

(57) ABSTRACT

Caption data incorporated in an input coded bit stream conveying a video service is processed by recovering the caption data from the input coded bit stream, decoding the input coded bit stream to form a digital video signal composed of a sequence of frames, embedding the caption data in an ancillary data space of the digital video signal, and encoding the digital video signal to produce an output coded bit stream incorporating the caption data.

### BACKGROUND OF THE INVENTION

The subject matter disclosed in this application relates to a method and apparatus for closed caption transcoding.

Referring to FIG. 1 of the drawings, a television program provider may operate a production facility 6 at which it produces a digital television (DTV) program signal AV having a baseband video component representing a sequence of pictures and at least one corresponding baseband audio component. We will assume for the purpose of this discussion that the baseband video component is in the high definition serial digital interface (HD-SDI) format specified in SMPTE 292M but it may be in another format, and in particular in the standard definition serial digital interface (SDI) format specified in SMPTE 259M.

SMPTE 292M defines an ancillary data space of the HD-SDI video signal. The baseband audio component may be embedded in the horizontal ancillary data space of the video component. SMPTE 334M specifies the format of data that can be embedded in the vertical ancillary (VANC) data space of the HD-SDI signal. Data that is formatted in accordance with SMPTE 334M can also be embedded in the VANC data space of the parallel data formats prescribed in SMPTE 274M (commonly referred to as 1080I) and SMPTE 296M (commonly referred to as 720P).

In order to distribute the DTV program signal to a wide audience of viewers, the program provider supplies the program signal to a satellite uplink operator. The uplink operator inputs the program signal to an encoder/multiplexer 8, which encodes the pictures using a video coding algorithm and thereby creates a bit stream that represents a corresponding sequence of coded pictures (also known as video access units). For the purpose of this description we shall assume that the video coding algorithm produces a bit stream that conforms to the video coding standard known as MPEG 4. The encoder/multiplexer also encodes the corresponding audio signal(s) and creates a bit stream representing a sequence of coded audio frames (also known as audio access units). The encoder/multiplexer 8 packetizes the bit streams as video and audio packetized elementary streams (PESs) and combines the video and audio PESs with video and audio PESs for other services offered by the program provider (or by other program providers) to form an MPEG multi-program transport stream (MPTS). A transmitter 10 employs the MPTS bit stream to modulate an RF carrier and transmits the modulated carrier via a satellite transponder (not shown) to a cable distribution system headend 12.

The headend 12 includes a receiver 14 that is tuned to the transmission frequency of the transponder and recovers the MPTS bit stream from the RF carrier and extracts the MPEG 4 bit streams from the MPTS.

MPEG 4 provides substantially better compression of video material than the video coding standard known as MPEG 2, but there is a large installed base of MPEG 2 set top decoders. Accordingly, although the uplink operator typically encodes the video material in compliance with MPEG 4 for transmission, as discussed above, the cable distribution system operator is constrained by the needs of the installed base to supply subscribers with video material encoded in compliance with MPEG 2. Therefore, the headend 12 includes transcoders 16 that transcode the MPEG 4 bit streams to MPEG 2 bitstreams.

FIG. 2 illustrates the topology of a commercially available transcoder 16. Referring to FIG. 2, the transcoder includes an MPEG 4 decoder 20 that receives the MPEG 4 bit stream and outputs the video component in HD-SDI format to a field programmable gate array (FPGA) that implements a receive buffer 22 and a SMPTE converter 24. The SMPTE converter receives the serial data provided by the MPEG 4 decoder and converts it to the parallel data format prescribed in SMPTE 274M or SMPTE 296M, depending on the video format of the HD-SDI signal. We will assume that the HD-SDI signal is a 720 line, progressive scan signal and that accordingly the target parallel data format is 720P. The receive buffer is provided to smooth out the flow of data to the SMPTE converter so that it can always produce a complete 720P frame. The 720P signal is provided to an MPEG 2 encoder 26, which may operate in conventional fashion and generate a bit stream in accordance with MPEG 2. Referring again to FIG. 1, a multiplexer 30 receives the MPEG 2 bitstreams and creates one or more MPTSs each containing several MPEG 2 services. Transmitters 32 transmit the MPTSs over a cable distribution network 34 to subscriber nodes 36 provided with decoding and presentation equipment.

The decoding and presentation equipment at a subscriber node may include a set top decoder 38 and a television set 40. The set top decoder includes suitable devices for selecting a service, decomposing the MPTS that contains the selected service, and decoding the audio and video bit streams for the selected service to create a DTV signal complying with Advanced Television Systems Committee (ATSC) standards. A newer television set may be adapted to display pictures conveyed by a DTV signal in accordance with the ATSC standards whereas many older television sets are only able to display pictures conveyed by an analog television signal in accordance with the National Television System Committee (NTSC) standard. Accordingly, the set top decoder typically includes a standards converter for converting the DTV signal to analog NTSC form and provides both a DTV output signal and an analog NTSC output signal.

The program provider may include a closed caption (CC) data component in the DTV program signal. The CC data, which provides one caption for each video frame, is in the form of caption distribution packets (CDPs) (as defined in CEA-708-B of the Consumer Electronics Association) embedded in the vertical ancillary (VANC) data space of the SDI signal AV that the program provider supplies to the uplink operator. When the SDI signal is encoded to produce the MPEG 4 bit stream, the CC data is incorporated in the MPEG 4 bit stream as supplementary enhancement information (SEI). Ideally, the transcoder 16 would recover the CC data from the SEI in the MPEG 4 bit stream and incorporate the CC data as user bits in the MPEG 2 bit stream. The set top decoder would decode the MPEG 2 data and include the caption data in the DTVCC Caption Channel of the ATSC signal that is provided to the television set 40, and a caption decoder in the television set, if enabled, would decode the caption data to legible text and key the text into the video frame for display.

In order to provide closed captions that will be displayed by an older television set, the MPEG 4 bit stream also carries “608 compatibility bytes” which enable a set top decoder to insert caption data complying with CEA-608-B of the Consumer Electronics Association in line 21 of the NTSC video signal.

A transcoder having the general form shown in FIG. 2 might not function in the ideal fashion described above, in that the MPEG 4 decoder might not properly decode the CC data included in the MPEG 4 bit stream and therefore the CC data would not be available for encoding into the MPEG 2 bit stream.

If the MPEG 4 decoder were able to decode the CC data from the MPEG 4 bit stream, there is a danger that the CC data included in the MPEG 2 bit stream would not be properly synchronized with the video frames. For example, errors in the signal AV or a poor RF signal may result in receive buffer overflow, such that video frames may be dropped from the MPEG 2 bit stream.

### SUMMARY OF THE INVENTION

In accordance with a first aspect of the invention there is provided a method of processing caption data incorporated in an input coded bit stream conveying a video service, comprising recovering the caption data from the input coded bit stream, decoding the input coded bit stream to form a digital video signal composed of a sequence of frames, embedding the caption data in an ancillary data space of the digital video signal, and encoding the digital video signal to produce an output coded bit stream incorporating the caption data.

In accordance with a second aspect of the invention there is provided apparatus for processing an input coded bit stream conveying a video service and in which caption data is incorporated, comprising a decoder for recovering the caption data from the input coded bit stream and decoding the input coded bit stream to form a digital video signal composed of a sequence of frames, a caption data packetizer for receiving the caption data and formatting the caption data for embedding in an ancillary data space of the digital video signal, and an embedding means for receiving the digital video signal and the formatted caption data and embedding the caption data in the ancillary data space of the digital video signal.

In accordance with a third aspect of the invention there is provided a programmable device having an input for receiving an input coded bit stream and an output for providing an output coded bit stream conveying a video service and in which caption data is incorporated, the programmable device being programmed to recover the caption data from the input coded bit stream, decode the input coded bit stream to form a digital video signal composed of a sequence of frames, embed the caption data in an ancillary data space of the digital video signal, and encode the digital video signal to produce the output coded bit stream, whereby the caption data is incorporated in the output coded bit stream.

### BRIEF DESCRIPTION OF THE DRAWINGS

For a better understanding of the invention, and to show how the same may be carried into effect, reference will now be made, by way of example, to the accompanying drawings, in which:

FIG. 1 is a simplified block diagram illustrating distribution of television program content,

FIG. 2 is a more detailed illustration of the transcoder shown in FIG. 1,

FIG. 3 is a block diagram illustrating a transcoder in accordance with the subject matter disclosed in this application,

FIG. 4 is a flow chart illustrating the normal mode of operation of the transcoder shown in FIG. 3,

FIG. 5 is a flow chart illustrating an aspect of the operation of the transcoder shown in FIG. 3, and

FIG. 6 is a schematic diagram of a computing machine that may be used to implement the functions described with reference to FIG. 3.

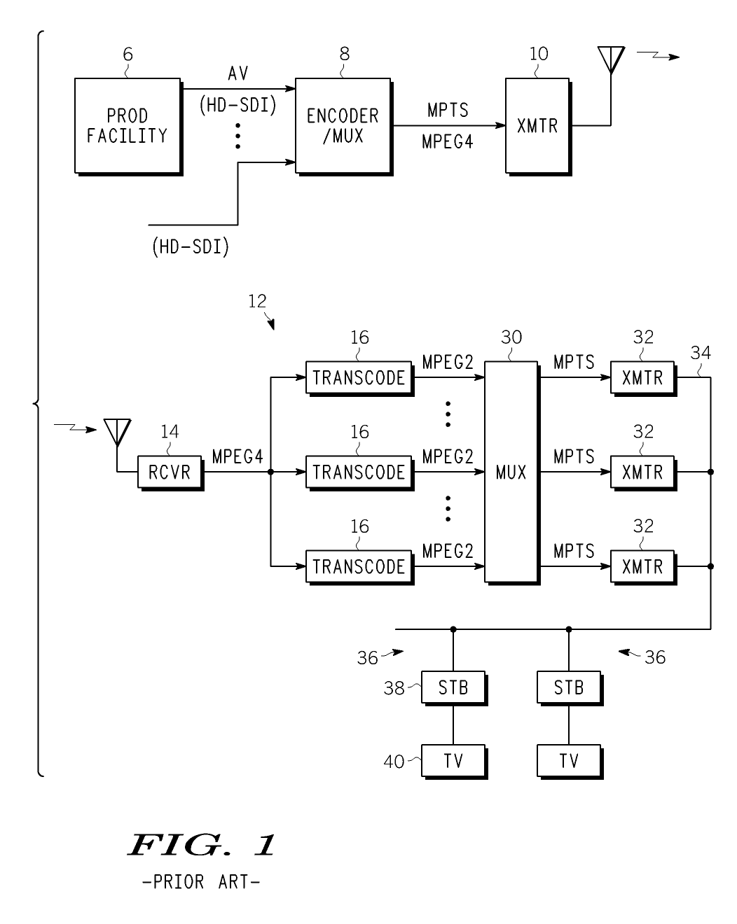

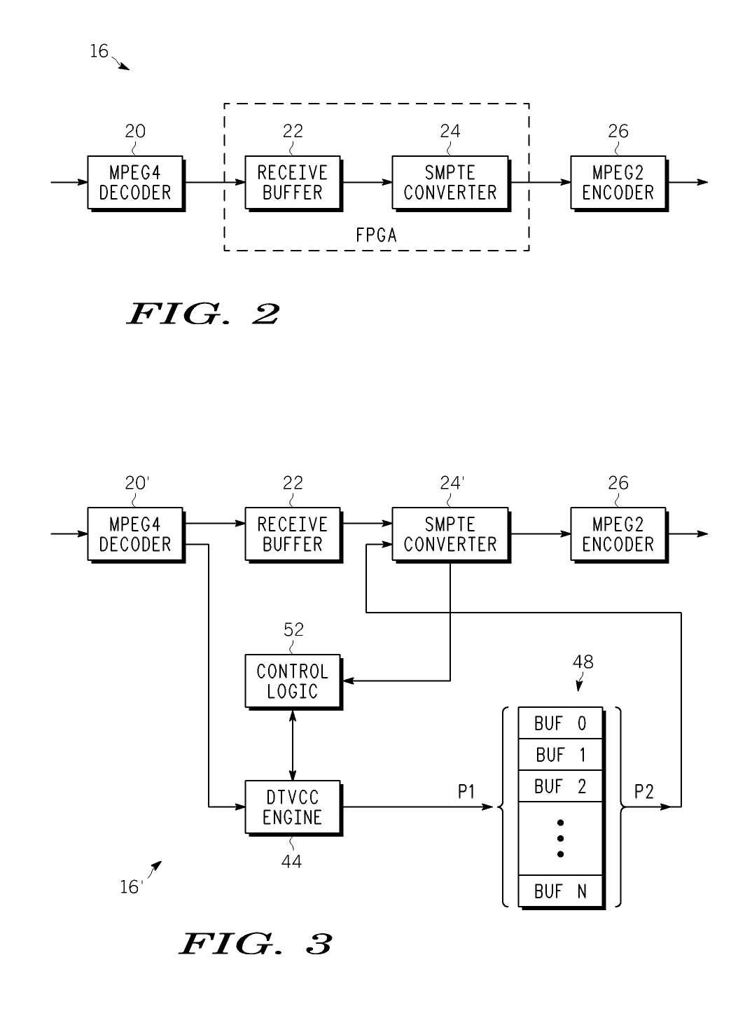

### DETAILED DESCRIPTION

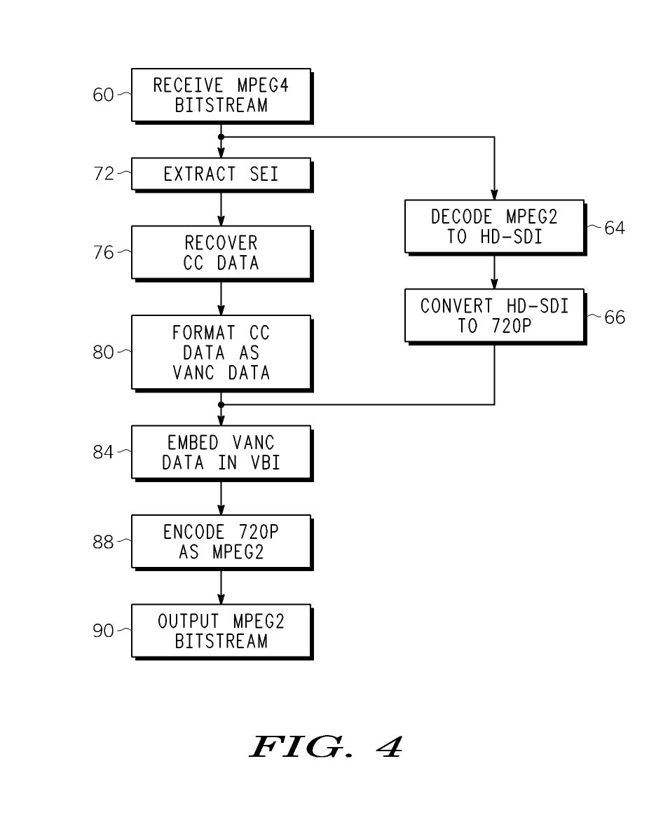

Let us assume initially that the bit stream received (FIG. 4, step 60) by the MPEG 4 decoder 20′ of the transcoder 16′ shown in FIG. 3 contains no errors and that all the pictures can be readily decoder by the decoder. The MPEG 4 decoder 20′ supplies (FIG. 4, step 64) a sequence of HD-SDI video frames HD-SDI 1, HD-SDI 2 etc. to the SMPTE converter 24′ via the receive buffer 22 and the SMPTE converter reformats (FIG. 4, step 68) the HD-SDI video frames as 720P frames. The decoder also extracts (FIG. 4, steps 72 and 76) the CC data, which contains both the 708 caption data and the 608 compatibility bytes for the current video frame, from the MPEG 4 bit stream and supplies the CC data to a DTVCC engine, or caption data packetizer, 44. The DTVCC engine 44 receives the CC data for the sequence of video frames and formats (FIG. 4, step 80) the CC data for each frame by adding a CDP header to the CC data and thereby generates a sequence of caption data packets CDP 1, CDP2, etc. corresponding to the video frames HD-SDI 1, HD-SDI 2 etc. respectively. The CDPs are generated at the same rate as the HD-SDI video frames and each CDP contains the CC data for the corresponding video frame in a form that complies with SMPTE 334M. The DTVCC engine supplies the sequence of CDPs to the SMPTE converter 24′ via a delay buffer 48 (discussed further below) and the SMPTE converter writes (FIG. 4, step 84) each CDP to a selected line of the vertical blanking interval (VBI) of the corresponding 720P frame as VANC data. Thus, each CDP is posted into the VBI of the proper 720P frame and the captions are thereby synchronized with the video frames.

The sequence of 720P frames, containing the corresponding CDPs, is provided to the MPEG 2 encoder 26, which encodes the 720P frames in an MPEG 2 bit stream and incorporates the VANC data as user data in the MPEG 2 bit stream (FIG. 4, steps 88 and 90). The set top decoder 38 recovers the 708 caption data and the 608 compatibility bytes and creates 708 captions for the ATSC output signal and inserts 608 captions on line 21 of the NTSC output signal.

The delay buffer 48 is implemented by the FPGA and compensates for the delay of the video frame in the receive buffer 22 and the SMPTE converter 24′ so that the 720P frame derived from HD-SDI 3, for example, is available to receive the corresponding caption data packet CDP 3 when the CDP is available from the delay buffer. Preferably, the delay buffer is a circular buffer containing multiple capture buffers (BUF 1, BUF 1, . . . BUF N) and which employs a read pointer, or end pointer, P1 pointing to the end of valid data in the circular buffer to read a CDP from the DTVCC engine and a write pointer, or start pointer, P2 pointing to the start of valid data to write a CDP to the selected line of the VBI of the 720P frame. Control logic 52 in the FPGA increments the read pointer P1 when the capture buffer reads a CDP from the DTVCC engine and increments the write pointer P2 when the SMPTE converter receives a video frame. After selecting BUF N, the pointer P1 or P2 wraps around to BUF 0. Still assuming that the CDPs and HD-SDI frames are generated at the same rate, the read pointer P1 leads the write pointer P2 by a constant offset K (1<K<N+1) corresponding to the required delay. Thus, during a frame interval in which the capture buffer uses the write pointer P2 to write a CDP to the SMPTE converter from BUF 0, the capture buffer uses the read pointer P1 to read a CDP from the DTVCC engine to BUF K.

There are circumstances in which the CDPs and the HD-SDI video frames are not generated at the same rate. In particular, the DTVCC engine may generate CDPs at a greater rate than that at which the decoder outputs HD-SDI frames. The transcoder 16′ provides a mechanism for detecting and correcting this problem.

If the MPEG 4 decoder outputs captions at a greater rate than it outputs video frames, the control logic increments the read pointer P1 more rapidly than the write pointer P2 and the value of K, which reflects the number of buffers that have not been read, increases. Should the read pointer advance so far relative to the write pointer as to wrap around and catch up with the write pointer, the CDP data would overflow the capture buffer and captions would be lost. Accordingly, in the event that the value of K exceeds a threshold value M (M<N), the control logic sets a flag to command the DVCC engine to stop sending CDPs and flushes the capture buffer. When the capture buffer is empty, the control logic clears the flag and the DTVCC engine resumes sending CDPs. In this manner, occurrence of errors in synchronization is detected and re-synchronization is achieved.

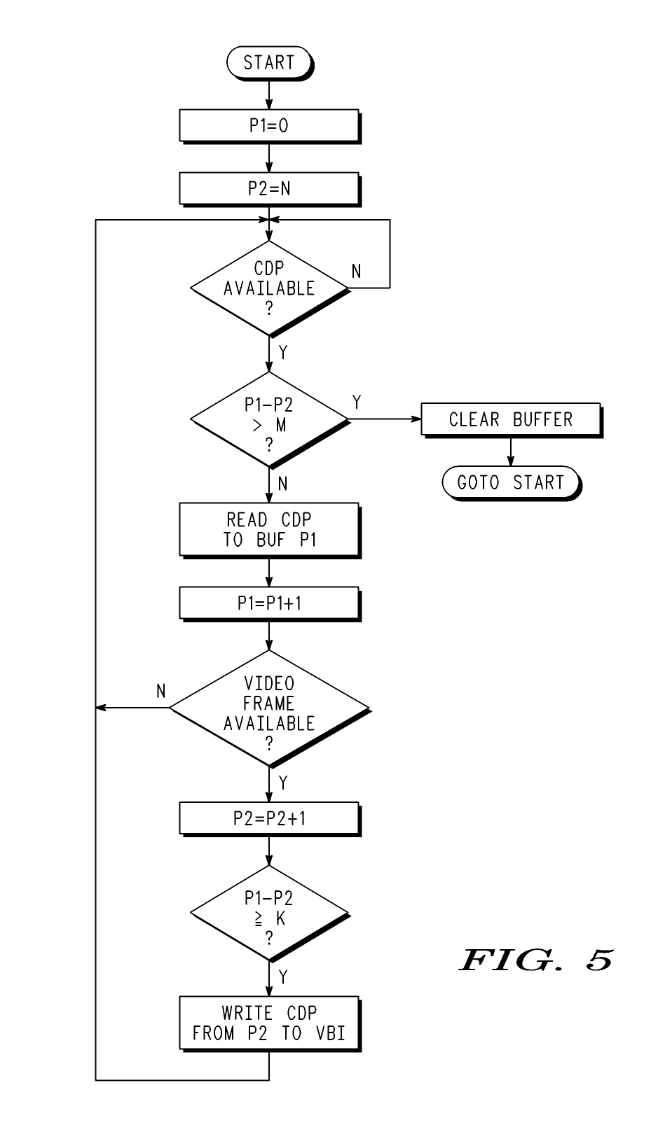

FIG. 5 is a flow chart that depicts in simplified form the operations performed by or in association with the control logic to detect and correct a situation in which the DTVCC engine generates CDP packets at a greater rate than the SMPTE converter receives video frames.

It is preferred that the MPEG 4 decoder and the MPEG 2 encoder be implemented by integrated circuit devices and that the receive buffer and SMPTE converter be implemented by an FPGA, as described above, because the FPGA is compact and inexpensive. However, other implementations are possible provided that they are able to meet the operating requirements, such as being able to process the incoming MPEG 4 bit stream at the required rate, which is typically in real time. For example, an ASIC may be used in lieu of an FPGA or a suitably programmed general purpose computer may be used to implement the entire transcoder.

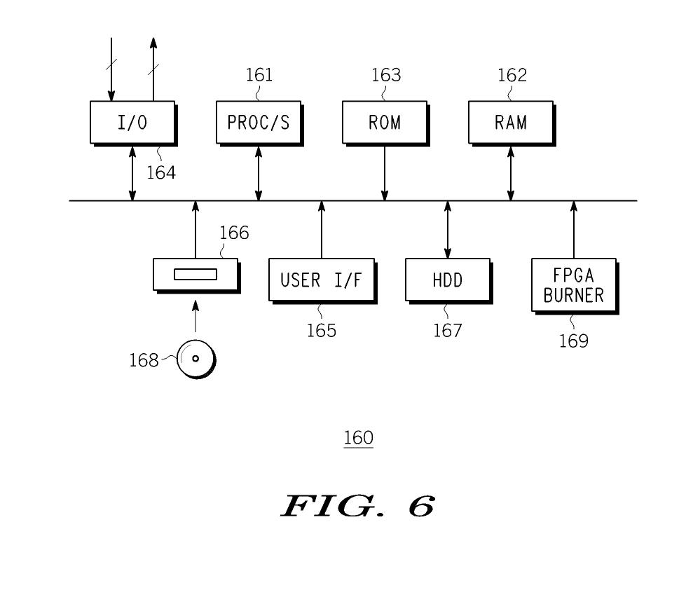

Referring to FIG. 6, a suitable general purpose computer 160 may comprise one or more processors 161, random access memory 162, read only memory 163, I/O devices 164, a user interface 165, a CD ROM drive 166 and a hard disk drive 167, configured in a generally conventional architecture. The computer operates in accordance with a program that is stored in a computer readable medium, such as the hard disk drive 167 or a CD ROM 168, and is loaded into the random access memory 162 for execution. The program is composed of instructions such that when the computer receives an MPEG 4 bit stream, as described above, by way of a suitable interface included in the I/O devices 164, the computer allocates memory to appropriate buffers and utilizes other suitable resources and functions to perform the various operations that are described above as being performed by the transcoder, with reference to the flow chart shown in FIG. 4.

It will be appreciated by those skilled in the art that the program might not be loadable directly from the CD ROM 168 into the random access memory utilizing the CD ROM drive 166 and that generally the program will be stored on the CD ROM or other program distribution medium in a form that requires the program to be installed on the hard disk drive 167 from the CD ROM 168.

Alternatively, in the event that the receive buffer and the SMPTE converter are implemented using an FPGA, the FPGA may be programmed using a general purpose computer of the form shown in FIG. 6, provided with a suitable FPGA burner 169 that communicates with the computer bus, for example using a serial port or a USB port. In this case, the program used to program the FPGA would be stored on the CD ROM 168 or on the hard disk drive 167.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of processing caption data incorporated in an input coded bit stream conveying a video service, comprising:
recovering the caption data from the input coded bit stream,
decoding the input coded bit stream to form a digital video signal composed of a sequence of frames,
embedding the caption data in an ancillary data space of the digital video signal, and
encoding the digital video signal to produce an output coded bit stream incorporating the caption data.

2. A method according to claim 1, wherein the input coded bit stream is an MPEG 4 bit stream and the caption data is incorporated in the MPEG 4 bit stream as supplemental enhancement information, and the step of recovering the caption data from the input coded bit stream comprises:
extracting the supplemental enhancement information from the input coded bit stream, and
recovering the caption data from the supplemental enhancement information.

3. A method according to claim 1, wherein the output coded bit stream is an MPEG 2 bit stream and the method comprises incorporating the caption data in the MPEG 2 bit stream as user bits.

4. A method according to claim 1, wherein the caption data recovered from the input coded bit stream specifies one caption for each frame of the sequence, and the method comprises creating a caption data packet for each frame of the video sequence, loading the caption data packets into respective buffers configured in a circular buffer array, writing the caption data packets from the buffers respectively into the respective ancillary data spaces of the corresponding video frames.

5. A method according to claim 4, comprising setting a read pointer for loading caption data packets into the circular buffer array, setting a write pointer for writing caption data packets from the circular buffer array, incrementing the read pointer when a caption data packet has been loaded into the circular buffer array, and incrementing the write pointer when a video frame is available for receiving a caption data packet.

6. A method according to claim 5, comprising monitoring difference between the read pointer and the write pointer and, in the event that the read pointer exceeds the write pointer by an amount that exceeds a threshold value, discontinuing loading caption data packets into the capture data buffer, clearing the capture data buffer, and then resuming loading caption data packets into the capture data buffer.

7. Apparatus for processing an input coded bit stream conveying a video service and in which caption data is incorporated, comprising:
a decoder for recovering the caption data from the input coded bit stream and decoding the input coded bit stream to form a digital video signal composed of a sequence of frames,
a caption data packetizer for receiving the caption data and formatting the caption data for embedding in an ancillary data space of the digital video signal, and
an embedding means for receiving the digital video signal and the formatted caption data and embedding the caption data in the ancillary data space of the digital video signal.

8. Apparatus according to claim 7, wherein the decoder is adapted to decode an input bit stream coded in compliance with MPEG 4 and to recover caption data incorporated in the MPEG 4 bit stream as supplemental enhancement information, and the decoder is operative to convert the input coded bit stream to a serial digital interface signal and to separate the supplemental enhancement information from the MPEG 4 bit stream.

9. Apparatus according to claim 7, wherein the caption data packetizer formats the caption data as caption data packets and the apparatus comprises a delay buffer for adjusting timing of the caption data packets relative to the video frames.

10. Apparatus according to claim 9, wherein the delay buffer is configured as a circular buffer that is accessed by a start pointer, for loading caption data packets into the delay buffer, and an end pointer, for removing caption data packets from the delay buffer, and the apparatus comprises control logic operative to increment the end pointer when a caption data packet for a video frame is received and to increment the start pointer when a video frame is received.

11. Apparatus according to claim 10, wherein the control logic is operative in the event that the end pointer exceeds the start pointer by an amount that exceeds a threshold value, to discontinue loading caption data packets into the delay buffer, clear the delay buffer, and then resume loading caption data packets into the delay buffer.

12. A programmable device having an input for receiving an input coded bit stream and an output for providing an output coded bit stream conveying a video service and in which caption data is incorporated, the programmable device being programmed to:
recover the caption data from the input coded bit stream,
decode the input coded bit stream to form a digital video signal composed of a sequence of frames,
embed the caption data in an ancillary data space of the digital video signal, and
encode the digital video signal to produce the output coded bit stream, whereby the caption data is incorporated in the output coded bit stream.

13. A device according to claim 12, wherein the device is operative to decode a bit stream encoded in compliance with MPEG 4 and recover the caption data from supplemental enhancement information incorporated in the MPEG 4 bit stream.

14. A device according to claim 14, wherein the device is operative to encode the digital video signal in compliance with MPEG 2 and incorporate the caption data as user bits in the MPEG 2 bit stream.

15. A device according to claim 12, configured to define a delay buffer for receiving the caption data for each video frame and for holding the caption data temporarily before embedding the caption data in the ancillary data space of the video frame.

16. A device according to claim 12, being a field programmable gate array.
